(19) United States
(12) Patent Application Publication
(10) Pub. No.: US 2005/0020347 A1
(43) Pub. Date: Jan. 27, 2005

(54) Gaming apparatus and method

(76) Inventor: Martin Moshal, Marina Bay (ZA)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 10/489,658

(22) PCT Filed: Sep. 19, 2002
(86) PCT No.: PCT/IB02/03859

(30) Foreign Application Priority Data
Sep. 21, 2001 (GB) 0122798.2

(51) Int. Cl. G06F 19/00; G06F 17/00

(52) U.S. Cl. 463/17

(57) ABSTRACT

A gaming apparatus comprises a server and a client computer, each operating under stored program control and in communication with each other by means of a communication network. The client computer is usable by a player to place a wager on an outcome of a particular spin of a roulette wheel, as well as a side ager on a combined outcome of the particular spin of the roulette wheel and one or more immediately preceding spins of the wheel. A portion of each side wager is accumulated in a pooled jackpot. Once the wagers have been placed, the gaming server randomly selects the outcome of the particular spin of the roulette wheel, and evaluates the success, or otherwise, of the side wager. The side wager is successful if the outcomes of the particular spin of the roulette wheel, and the immediately preceding spins are identical. The outcome of the particular spin of the roulette wheel and the success, or otherwise, of the side wager are transmitted by the gaming server along the communication network to the client computer for display to the player. A successful side wager wins for the player the accumulated contents of the pooled jackpot.

### FIELD OF THE INVENTION

This invention relates to a gaming apparatus, more particularly to an apparatus for playing a game of chance and, more specifically, to an apparatus for playing a variation of a game of roulette. The invention extends to a method for gaming.

### BACKGROUND TO THE INVENTION

The game of roulette is well known and widely played in most land-based and online casinos.

At the simplest level, in a conventional game of roulette, a player may place a wager associated with any one or more of 37 locations on a playing surface. A number in the range 0 to 36 uniquely identifies each location on the playing surface, and each location has a corresponding colour that is red, black or green. The outcome of the game is determined by a spin of the ball against a rotating roulette wheel having 37 positions in which the ball may come to rest, each position being uniquely identified by a number in the range 0 to 36, respectively. This version of the game is known in the art as “European” roulette.

A variant of the roulette game described above is known as “American” roulette and is one in which the playing surface has 38 locations, each identified uniquely by a number 0 to 36, as well as the “number” 00.

In the description that follows, the invention will be described with reference to the European version of the roulette game. It is to be clearly understood, however, that the invention is also applicable to the American version of the game.

If the ball comes to rest in a position corresponding to a location on the playing surface on which the player has placed a wager, the player is paid an amount of 35 times the size of the wager. All other wagers on the playing surface are forfeited to an operator of the roulette game.

Additional types of wagers are allowed on the playing surface, such as a wager on either one of two, three, four or six adjacent locations, a wager on any one of locations 1 to 12, 13 to 24, or 25 to 36, a wager on any one of the numbers in any column arrangement on the playing surface, a wager on any even or any odd number, a wager on any red location or any black location, or a wager on any one of the locations 1 to 18, or 19 to 36. The payout on successful wagers of these types is determined to give an appropriate advantage to the operator of the roulette game.

A disadvantage of the game of conventional roulette, as described above, is that the outcome of any particular wager is determined by a single spin of the roulette wheel, which can cause the player's interest in the game to wane rapidly.

### OBJECT OF THE INVENTION

It is an object of this invention to provide an gaming apparatus and a method for gaming that will, at least partially, alleviate the above-mentioned disadvantage by retaining the player's interest in the game over a number of successive turns of the game.

### SUMMARY OF THE INVENTION

In accordance with this invention there is provided a method for playing a game of chance, which includes the steps of:
placing a wager on an outcome of a particular spin of a roulette wheel; and
placing a corresponding side wager on a combined outcome of the particular spin of the roulette wheel and at least one other spin of the roulette wheel.

Further features of the invention provide for placing the side wager on a combined outcome of the particular spin of the roulette wheel and a plurality of other spins of the roulette wheel.

Still further features of the invention provide for the at least one other spin of the roulette wheel to be a preceding spin of the roulette wheel, for the particular spin of the roulette wheel and the at least one preceding spin of the roulette wheel to be consecutive spins of the wheel, for the plurality of other spins of the roulette wheel to be a plurality of preceding spins of the roulette wheel, and for the particular spin of the roulette wheel and the plurality of preceding spins of the roulette wheel to all be consecutive spins of the wheel.

Yet further features of the invention provide for accumulating a portion, preferably at least 1 percent, of each side wager in a pooled jackpot, for providing that the pooled jackpot exceeds a predetermined minimum amount at all times, and for incrementing the pooled jackpot at a predetermined rate even when no wagers are placed on an outcome of a spin of the roulette wheel.

There is further provided for the side wager to be successful if a same ourcome occurs on the particular spin of the roulette wheel and an immediately preceding spin of the roulette wheel, for paying such a successful side wager an amount of 15 times the size of the side wager, for the side wager to also be successful if a same outcome occurs on the particular spin of the roulette wheel and the immediately preceding two spins of the roulette wheel, for paying such a successful side wager an amount of 200 times the size of the side wager, for the side wager to also be successful if a same outcome occurs on the particular spin of the roulette wheel and the immediately preceding three spins of the roulette wheel, for paying such a successful side wager an amount of 3000 times the size of the side wager, for the side wager to also be successful if a same outcome occurs on the particular spin of the roulette wheel and the immediately preceding four spins of the roulette wheel, and for paying such a successful side wager an accumulated amount in the pooled jackpot.

The invention extends to a method of operating a gaming server, comprising the steps of:
randomly selecting an outcome of a particular spin of a roulette wheel;
transmitting, along a communication network, a signal containing data representative of the outcome of the particular spin of the roulette wheel; and evaluating the success of a side wager placed by a player as a function of the outcome of the particular spin of the roulette wheel and at least one other spin of the roulette wheel.

There is also provided for the method to include the further step of accumulating a portion of the side wager in a pooled jackpot, for the success of the side wager to be evaluated as a function of the outcomes of the particular spin of the roulette wheel and a plurality of other spins of the roulette wheel.

There is also provided for the side wager to be successful if a same outcome occurs on the particular spin of the roulette wheel and the preceding spin of the roulette wheel, for the successful side wager to be paid an amount of 15 times the size of the side wager, for side wager is successful if a same outcome occurs on the particular spin of the roulette wheel and the preceding two spins of the roulette wheel, for the successful side wager to be paid an amount of 200 times the size of the side wager, for the side wager to be successful if a same outcome occurs on the particular spin of the roulette wheel and the preceding three spins of the roulette wheel, for the successful side wager to be paid an amount of 3000 times the size of the side wager, for the side wager to be successful if a same outcome occurs on the particular spin of the roulette wheel and the preceding four spins of the roulette wheel, and for the successful side wager to be paid the accumulated amount in the pooled jackpot.

The invention extends further to a method operating a client computer, comprising steps of:
enabling a player to place a wager on an outcome of a particular spin of a roulette wheel;
enabling the player to place a corresponding side wager on a combined outcome of the particular spin of the roulette wheel and at least one other spin of the roulette wheel;
transmitting, along a communication network, a request to a gaming server, to randomly select an outcome of the particular spin of the roulette wheel;
receiving, along the communication network, a response from the gaming server containing data representative of the outcome of the particular spin of the roulette wheel and the success of the side wager; and
displaying the outcome of the particular spin of the roulette wheel and the success of the side wager as part of a simulation of a game of roulette.

The invention extends still further to a system for playing a game of chance, comprising:
means for placing a wager on an outcome of a particular spin of a roulette wheel; and
means for placing a corresponding side wager on a combined outcome of the particular spin of the roulette wheel and at least one other spin of the roulette wheel.

There is further provided for the side wager to be on a combined outcome of the particular spin of the roulette wheel and a plurality of other spins of the roulette wheel.

There is still further provided for the at least one other spin of the roulette wheel to be a preceding spin of the roulette wheel, for the particular spin of the roulette wheel and the at least one preceding spin of the roulette wheel to be consecutive spins of the wheel, for the plurality of other spins of the roulette wheel to be a plurality of preceding spins of the roulette wheel, and for the particular spin of the roulette wheel and the plurality of preceding spins of the roulette wheel to all be consecutive spins of the wheel.

There is yet further provided for the system to include a pooled jackpot, for the pooled jackpot to accumulate a portion, preferably at least 1 percent, of each side wager, for the pooled jackpot to exceed a predetermined minimum amount at all times, and for the pooled jackpot to increment at a predetermined rate even when no wagers are placed on an outcome of a spin of a roulette wheel.

There is further provided for the side wager to be successful if a same outcome occurs on the particular spin of the roulette wheel and the immediately preceding spin of the roulette wheel, for such a successful side wager to pay an amount of 15 times the size of the side wager, for the side wager to also be successful if a same outcome occurs on the particular spin of the roulette wheel and the immediately preceding two spins of the roulette wheel, for such a successful side wager to pay an amount of 200 times the size of the side wager, for the side wager to also be successful if a same outcome occurs on the particular spin of the roulette wheel and the immediately preceding three spins of the roulette wheel, for such a successful side wager to pay an amount of 3000 times the size of the side wager, and for the side wager to also be successful if a same outcome occurs on the particular spin of the roulette wheel and the preceding four spins of the roulette wheel, and for such a successful wager to pay the accumulated amount in the pooled jackpot.

The invention extends yet further to a computer generated message containing data representative of an outcome of a particular spin of a roulette wheel and the success or failure of a side wager on a combined outcome of the particular spin of the roulette wheel and at least one other spin of the roulette wheel.

### BRIEF DESCRIPTION OF THE DRAWINGS

A preferred embodiment of the invention is described below, by way of example only, and with reference to the accompanying drawings, in which:

FIG. 1 is a functional representation of a gaming apparatus, according to the invention.

### DETAILED DESCRIPTION OF THE INVENTION

An embodiment of a gaming apparatus for playing a game includes means for placing a wager on an outcome of a next spin of a roulette wheel. The means for placing the wager is in the form of a playing surface having 37 locations demarcated thereon. The arrangement of the demarcated locations on the playing surface is the same as that of a conventional roulette table. A number in the range 0 to 36 and a corresponding colour that is red, black or green identifies each one of the playing locations on the playing surface. A location on the playing surface identified by the number 0 is green, whilst half of the remaining locations are red in colour, the others being black. The gaming apparatus includes, further, a rotatable roulette wheel and a ball. The outcome of the game is determined by a spin of the ball against the rotating roulette wheel, which has 37 positions in which the ball may come to rest at random, each position being uniquely identified by a number in the range 0 to 36, respectively.

A player may place any wager on the playing surface that is allowed in a conventional game of roulette. There are many such wagers, which are well known in the art, and which will not be described here in detail. The success, or otherwise of a conventional wager is determined by the outcome of the spin of the wheel.

The playing surface includes means for placing a corresponding side wager on the game of chance, in the form of a demarcated location for placing the side wager thereon, as will be described in detail in the description that follows.

In order to use the gaming apparatus, a player is required to place one or more conventional wagers on the playing surface. The player is also required to place a side wager in the location on the playing surface for this purpose. Failure by the player to make the side wager will exclude the player from participation in the game.

A portion consisting of at least 1% of the amount of each side wager is accumulated in a pooled jackpot, the running total of which is displayed to the player. The pooled jackpot exceeds a minimum amount, in this embodiment 5 001 currency units, at all times. The pooled jackpot also accumulates at a predetermined base rate of 0,001 currency units per second even when no player is playing the game.

Once the player has placed his chosen conventional wagers, as desired, and the side wager, as required, the roulette wheel is spun until the ball comes to rest in one of the 37 locations thereon. The outcome of the conventional wagers is determined according to the rules of a conventional game of roulette, while the outcome of the side wager is determined as follows:
1. the side wager will be successful if the number occurring on the spin of the roulette wheel is the same as the number which occurred on the preceding spin of the roulette wheel. In such an instance, the successful wager is paid an amount of 15 times the size of the side wager,
2. the side wager will also be successful if the number occurring on the spin of the roulette wheel is the same as the number which occurred on each of the preceding two spins of the roulette wheel. In such an instance, the successful wager is paid an amount of 200 times the size of the side wage;
3. the side wager will also be successful if the number occurring on the spin of the roulette wheel is the same as the number which occurred on each of the preceding three spins of the roulette wheel. In such an instance, the successful wager is paid an amount of 3000 times the size of the side wager;
4. the side wager will also be successful if the number occurring on the spin of the roulette wheel is the same as the number which occurred on each of the preceding four spins of the roulette wheel. In such an instance, the successful wager is paid an accumulated amount of the pooled jackpot.

It will be appreciated by those skilled in the art that the side wager made by the player in the manner described above is, in fact, a wager that an unbroken progression of the same number will occur on successive spins of the roulette wheel. It is therefore also necessary to display to the player the outcome of previous spins of the roulette wheel on a history palette in order to assist the player in determining an appropriate time to enter or to leave the game. The outcome of the side wager is thus dependent on more than a single spin of the roulette wheel and it is anticipated that the side wager, together with the pooled jackpot, will help to sustain the player's interest in the game over a period of time.

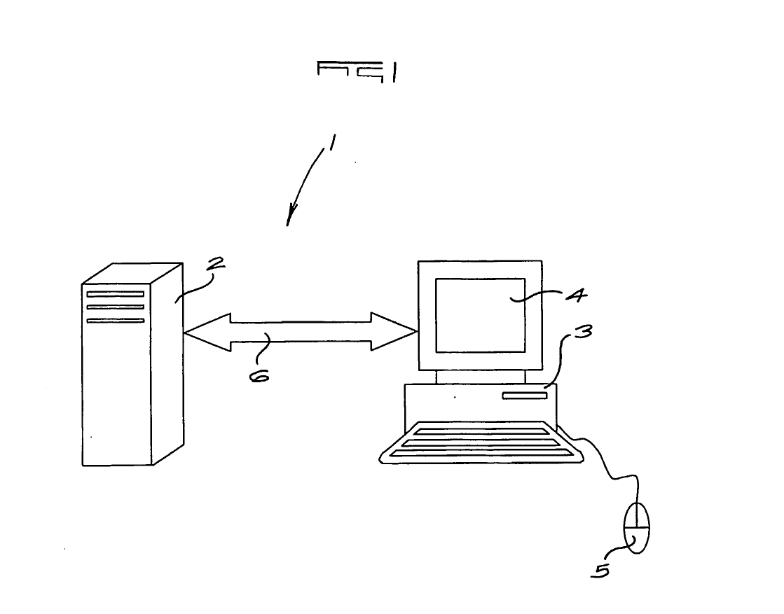

The invention may be embodied either as a table game, as described above, or as an online game, as described below in a further embodiment of the invention, with reference to FIG. 1 of the drawings.

In this embodiment, a gaming apparatus is indicated generally by reference numeral (1). The system (1) comprises a gaming server (2) and a player terminal (3) in the form of a computer workstation with an associated display monitor (4) and a pointing device (5) such as a mouse or a touchpad. The computer workstation (3) is located remotely from the gaming server (2) and is connected thereto by means of a communication network (6) that is, in this embodiment, the World Wide Web of the Internet.

The computer workstation (3) is a conventional personal computer operating under a Windows 2000 operating system, which is well known and commercially available from Microsoft Corporation of Seattle, Wash., USA. The computer workstation (3) executes a stored simulation software program that simulates the progress of a variation of a game of roulette. The operation of the simulation program will be described in more detail in the description that follows.

The gaming server (2) includes a computer program for generating random events that determine the progress of the variation of the game of roulette. In particular, the random event generation program is executable on the on the gaming server (2) to select, on a random basis, a number between 0 and 36, which corresponds to the ball coming to rest at random in one of 37 positions on the roulette wheel after being spun against the rotating wheel. The operation of such a random event generation programs is well known in the art and will not be described here in detail.

A player wishing to use the gaming apparatus (1) is first required to register and to create an account on the gaming server (2). The player is then required to pre-fund the account by purchasing credit that will, for convenience, be denominated in this description in “units”. The gaming server (2) stores a credit balance corresponding to the player's account at all times.

In order to commence, the player uses the computer workstation (3) to log onto the gaming server (2) and initiates execution of the simulation program, which causes a playing surface similar to that of a conventional roulette table to be displayed on the monitor (4). The player now enters a betting phase of the game by making one or more wagers on the playing surface. The player may make any wager that is permitted in a conventional game of roulette. The sizes of the players various wagers are displayed on the playing surface. There must be sufficient credit in the player's account to cover any wager that is made. Data relating to the type and size of each such conventional wager made by the player is transmitted by the computer workstation (3) across the communication network (6) to the gaming server (2) for storage on an associated storage device (not shown).

The layout of the playing surface includes a bet placement icon that can be used by the player to place a corresponding side wager on the turn of the game. The side, which is of a fixed size, is compulsory and the game may not proceed until the player has made the side wager. As is the case with conventional wagers, data relating to the side wager made by the player is transmitted by the computer workstation (3) across the communication network (6) to the gaming server (2) for storage. The gaming server (2) accumulates 1% of the amount of each side wager in a pooled jackpot, a running total of which is maintained by the gaming server for display to the player. The pooled jackpot exceeds a minimum amount of 5001 units at all times, at all times. The pooled jackpot also accumulates at a predetermined base rate of 0,001 currency units per second even when no player is playing the game.

The simulation program on the computer workstation also causes a “Spin” icon to be displayed on the display monitor (4) that, when activated by the player by means of the pointing device (5), begins a playing phase of the game in which a number between 0 and 36 is randomly selected by the gaming server (2) and displayed by the simulation program on the display monitor (4). Activation of the “Spin” icon by the player causes a message to be transmitted to the gaming server (2) across the communication network (6), which causes the execution of the event generation program on the gaming server to randomly select a number between 0 and 36. The gaming server (2) transmits the randomly selected number across the communication network (6) back to the computer workstation (3) where the simulation program highlights the selected number on the displayed playing surface. The simulation program also displays, on the display monitor (4) a history palette in the form of a scrolling window that displays the randomly selected numbers in the most recent four turns of the game.

The gaming server (2) settles the players conventional wagers and the side wager as a function of the randomly selected number as described above and the stored data relating to the conventional and side wagers made by the player. The wagers that are determined as being winning wagers are highlighted on the display monitor (4).

The gaming server (2) transmits the player's credit account balance across the communication network (6) to the computer workstation (3) from time to time. The simulation program displays this balance to the player in real time on the display monitor (4) to indicate a quantity of credit that is available to the player for playing the game. The credit balance is adjusted with each turn of the game in accordance with wagers placed and won or lost by the player.

Once the player's conventional and side wagers have been settled as described above, the turn of the game is complete and the player may begin a further turn of the game by making one or more other conventional wagers and a corresponding side wager.

It will be further appreciated by those skilled in the art that multiple computer workstations (3) can be linked to the gaming server (2) by means of the communication network (6), allowing multiple players to utilize the system (1) simultaneously and to be served by the gaming server. The gaming server (2) then accumulates 1% of the amount of the side wager of any one of the multiple players in a single common pooled jackpot. The common pooled jackpot will thus grow at a rate proportional to the number of simultaneous players and is anticipated to grow rapidly, thus becoming more attractive to potential players.

Numerous modifications are possible to this embodiment without departing from the scope of the invention. In particular, the amounts paid to the player in respect of a successful side wager may be different to those illustrated above, in order to make the game more attractive to the player. Further, the game may be played according to rules that the progression of the same number may not need to be unbroken in order for the side wager to be successful. For example, it may be sufficient for the same number to occur 2, 3, 4 or 5 times on the next subsequent spin of the roulette wheel and any of the immediately preceding four spins of the roulette wheel. Still further, the success of the side wager may be dependent on the combined outcome of the next, and subsequent, spins of the roulette wheel or, alternatively, may be dependent on the combined outcome of the next spin of the roulette wheel and the outcome of both preceding and subsequent spins of the roulette wheel. Yet further, the pooled jackpot may accumulate from side wagers placed on a plurality of different roulette games being played simultaneously.

The technical problem solved by this invention is that of transforming a game of conventional roulette into a progressive game and, further, to enabling multiple players of the game to simultaneously contribute to, and to compete for, a single progressive jackpot associated with a game of conventional roulette.

The invention therefore provides a novel variation of a conventional game of roulette that will enhance and extend a player's interest in the game.

1-49. (canceled)

50. A method for gaming, which includes the steps of:
placing a wager on the occurrence of a selected outcome of a particular spin of a roulette wheel;
placing a corresponding compulsory side wager on the occurrence of a non-selectable combined outcome that is a function of the respective outcomes of the particular spin of the roulette wheel and at least one other spin of the roulette wheel; and
inhibiting the particular spin of the roulette wheel until the compulsory side wager has been placed.

51. A method as claimed in claim 50 in which the compulsory side wager is successful if the respective outcomes of the particular spin of the roulette wheel and the at least one other spin of the roulette wheel are identical.

52. A method as claimed in claim 51 in which the particular spin of the roulette wheel and the at least one other spin of the roulette wheel are consecutive spins of the roulette wheel.

53. A method as claimed in claim 51 in which the at least one other spin of the roulette wheel is a preceding spin of the roulette wheel.

54. A method as claimed in claim 53 in which the at least one other spin of the roulette wheel is a plurality of different preceding spins of the roulette wheel.

55. A method as claimed in claim 50 that includes the steps of:
accumulating a portion of each compulsory side wager in a pooled jackpot; and
providing that a balance of the pooled jackpot exceeds a predetermined minimum amount at all times.

56. A method as claimed in claim 55 that includes the step of incrementing the pooled jackpot at a predetermined rate even when no wagers are placed on an outcome of a spin of the roulette wheel.

57. A method as claimed in claim 53 in which the successful compulsory side wager is paid at odds of 15 to 1 if a same outcome occurs on the particular spin of the roulette wheel and the preceding spin of the roulette wheel.

58. A method as claimed in claim 54 in which the successful side wager is paid at odds of 200 to 1 if a same outcome occurs on the particular spin of the roulette wheel and two preceding spins of the roulette wheel.

59. A method as claimed in claim 54 in which the successful compulsory side wager is paid at odds of 3000 to 1 if a same outcome occurs on the particular spin of the roulette wheel and three preceding spins of the roulette wheel.

60. A method as claimed in claim 54 in which the successful compulsory side wager is paid the accumulated amount in the pooled jackpot if a same outcome occurs on the particular spin of the roulette wheel and four preceding spins of the roulette wheel.

61. A method of operating a game server, comprising the steps of:
receiving a signal containing data relating to a wager placed on the occurrence of a selected outcome of a particular spin of a roulette wheel;
pausing until receipt of data relating to a corresponding compulsory side wager on the occurrence of a non-selectable combined outcome that is a function of the respective outcomes of the particular spin of the roulette wheel and at least one other spin of the roulette wheel;
randomly selecting an outcome of the particular spin of the roulette wheel;
determining the success of the compulsory side wager; and
transmitting a signal containing data representative of the outcome of the particular spin of the roulette wheel and the success of the compulsory side wager.

62. A method as claimed in claim 61 in which the compulsory side wager is determined as being successful if the respective outcomes of the particular spin of the roulette wheel and the at least one other spin of the roulette wheel are identical.

63. A method as claimed in claim 62 in which the particular spin of the roulette wheel and the at least one other spin of the roulette wheel are consecutive spins of the roulette wheel.

64. A method as claimed in claim 62 in which the at least one other spin of the roulette wheel is a preceding spin of the roulette wheel.

65. A method as claimed in claim 64 in which the at least one other spin of the roulette wheel is a plurality of different preceding spins of the roulette wheel.

66. A method as claimed in claim 61 that includes the steps of:
accumulating a portion of each compulsory side wager in a pooled jackpot; and
providing that a balance of the pooled jackpot exceeds a predetermined minimum amount at all times.

67. A method as claimed in claim 64 in which the successful compulsory side wager is paid at odds of 15 to 1 if a same outcome occurs on the particular spin of the roulette wheel and the preceding spin of the roulette wheel.

68. A method as claimed in claim 65 in which the successful compulsory side wager is paid at odds of 200 to 1 if a same outcome occurs on the particular spin of the roulette wheel and two preceding spins of the roulette wheel.

69. A method as claimed in claim 65 in which the successful compulsory side wager is paid at odds of 3000 to 1 if a same outcome occurs on the particular spin of the roulette wheel and three preceding spins of the roulette wheel.

70. A method as claimed in claim 65 in which the successful compulsory side wager is paid the accumulated amount in the pooled jackpot if a same outcome occurs on the particular spin of the roulette wheel and four preceding spins of the roulette wheel.

71. A method of operating a client computer, comprising the steps of:
enabling a player to place a wager on the occurrence of a selected outcome of a particular spin of a roulette wheel;
enabling the player to place a corresponding compulsory side wager on the occurrence of a non-selectable combined outcome that is a function of the respective outcomes of the particular spin of the roulette wheel and at least one other spin of the roulette wheel;
transmitting at least one message containing data relating to the wager and to the compulsory side wager, to a gaming server, and a request to randomly select an outcome of the particular spin of the roulette wheel;
receiving a response from the gaming server containing data representative of the outcome of the particular spin of the roulette wheel and the success of the compulsory side wager; and
displaying the outcome of the particular spin of the roulette wheel and the success of the side wager as part of a simulation of a game of roulette.

72. A gaming apparatus, comprising:
a gaming server operable under program control to regulate the progress of a game of roulette;
a player station remote from the gaming server, the player station being operable to display a simulation of a game of roulette;
a communication network providing communication between the gaming server and the player station;
a wagering means operable by the player to place a wager on the occurrence of a selectable outcome of a particular turn of the game of roulette, and a corresponding compulsory side wager on the occurrence of a non-selectable combined outcome that is a function of the respective outcomes of the particular turn of the game of roulette and at least one other turn of the roulette game, the gaming server being arranged to inhibit the progress of the particular turn of the game of roulette until the compulsory side wager has been placed.

73. A gaming apparatus as claimed in claim 72 in which the compulsory side wager is successful if the respective outcomes of the particular turn of the roulette game and the at least one other turn of the roulette game are identical.

74. A gaming apparatus as claimed in claim 73 in which the particular turn of the roulette game and the at least one other turn of the roulette game are consecutive turns of the roulette game.

75. A gaming apparatus as claimed in claim 73 in which the at least one other turn of the roulette game is a preceding turn of the roulette game.

76. A gaming apparatus as claimed in claim 75 in which the at least one other turn of the roulette game is a plurality of different preceding turns of the roulette game.

77. A gaming apparatus as claimed in claim 72 in which the gaming server accumulates a portion of each compulsory side wager in a pooled jackpot, and maintains a balance of the pooled jackpot above a predetermined minimum amount at all times.

78. A gaming apparatus as claimed in claim 77 in which the gaming server increments the pooled jackpot at a predetermined rate even when no wagers are placed on an outcome of a turn of the roulette game.

79. A gaming apparatus as claimed in claim 75 in which the gaming server pays the successful compulsory side wager at odds of 15 to 1 if a same outcome occurs on the particular turn of the roulette game and the preceding turn of the roulette game.

80. A gaming apparatus as claimed in claim 76 in which the gaming server pays the successful compulsory side wager at odds of 200 to 1 if a same outcome occurs on the particular turn of the roulette game and two preceding turns of the roulette game.

81. A gaming apparatus as claimed in claim 76 in which the gaming server pays the successful compulsory side wager at odds of 3000 to 1 if a same outcome occurs on the particular turn of the roulette game and three preceding turns of the roulette game.

82. A gaming apparatus as claimed in claim 76 in which the gaming server pays the successful compulsory side wager the accumulated amount in the pooled jackpot if a same outcome occurs on the particular turn of the roulette game and four preceding turns of the roulette game.

83. A computer generated message containing data representative of an outcome of a particular spin of a roulette wheel and the success or failure of a compulsory side wager on a combined outcome of the particular spin of the roulette wheel and at least one other spin of the roulette wheel.
